(19) United States
(12) Patent Application Publication
(10) Pub. No.: US 2006/0025504 A1
(43) Pub. Date: Feb. 2, 2006

(54) Process aid for melt processable polymers that contain hindered amine light stabilizer

(76) Inventor: Steven Richard Oriani, Landenberg, PA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 11/175,590

(22) Filed: Jul. 6, 2005

Related U.S. Application Data
(60) Provisional application No. 60/592,265, filed on Jul. 29, 2004.

(51) Int. Cl. C08K 5/32

(52) U.S. Cl. 524/236

(57) ABSTRACT

Extrusion processability of non-fluorinated melt-processable polymers that contain hindered amine light stabilizer (HALS) is improved by introducing a fluoropolymer process aid comprising a) copolymerized units of i) at least 15 weight percent vinylidene fluoride and ii) at least one other fluorine-containing copolymerizable monomer; b) a polycaprolactone polymer; and c) a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof.

### CROSS-REFERENCE TO RELATED APPLICATIONS

This application claims the benefit of U.S. Provisional Application No. 60/592,265 filed Jul. 29, 2004.

### FIELD OF THE INVENTION

The present invention relates to extrusion of non-fluorinated melt-processable polymers which contain a hindered amine light stabilizer, a fluoropolymer processing aid, a polycaprolactone interfacial agent and a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof.

### BACKGROUND OF THE INVENTION

The melt extrusion of high molecular weight polymers, for example, hydrocarbon polymers and polyamides, into shaped structures such as tubing, pipe, wire coating or film is accomplished by well-known procedures wherein a rotating screw pushes a viscous polymer melt through an extruder barrel into a die in which the polymer is shaped to the desired form and is then subsequently cooled and solidified into a product having the general shape of the die.

In order to achieve low production costs, it is desirable to extrude the polymer at rapid rates. Higher extrusion rates may be readily obtained by increasing the rate of revolution of the extruder screw. However, this technique is subject to limitations imposed by the viscoelastic properties of the polymer substrate. Thus, at very high extrusion rates an unacceptable amount of thermal decomposition of the polymer can result. Further, extrudates having a rough surface are often obtained which can lead to formation of an undesirable pattern on the surface of the extrudate. These surface defects are also known as melt fracture. Extrusion at elevated temperatures obviates this problem but adds to processing costs. Also, cooling of the extrudate becomes problematic. In addition, if polyolefins are extruded at temperatures near their decomposition points, polymer degradation occurs.

It is desirable, therefore, to find highly efficient means of increasing the extrusion rate without raising the melt temperature, while producing articles having smooth surfaces.

In Blatz, U.S. Pat. No. 3,125,547, it is disclosed that the use of 0.01-2.0 wt. % of a fluoropolymer that is in a fluid state at the processing temperature (e.g. a fluoroelastomer) will reduce die pressure in extrusions of both high and low density polyethylenes, as well as other polyolefins. Further, use of this additive allows significant increase in extrusion rates without melt fracture. The fluoropolymer forms a coating on the extruder die surface that results in improved processability.

More recently, improved fluoropolymer process aid compositions have been disclosed in, for example, U.S. Pat. Nos. 4,855,360; 5,587,429 and 5,707,569. In these fluoropolymer process aid compositions, a second additive, such as a poly(oxyalkylene) or an ionomer resin, is introduced in order to improve extrusion processability of the non-fluorinated polymer.

U.S. Pat. No. 6,642,310 B2 discloses fluoropolymer process aid compositions wherein the fluoropolymer has a relatively large weight average particle size (about 2-10 microns) as measured at a point in the extrusion process near the die. Process aid compositions that contain an optional interfacial agent, such as a polycaprolactone, work especially well.

Some non-fluorinated melt processable polymer compositions contain hindered amine light stabilizers (HALS). Examples of HALS include those sold under the trade names of Chimassorb®, Tinuvin®, and Cyasorb®. Fluoropolymer process aids that are based on copolymerized units of vinylidene fluoride do not perform well in such melt processable polymers. It is theorized that either the basic HALS reacts with acidic hydrogen atoms on the vinylidene fluoride-containing fluoropolymer process aid, or that the HALS competes with fluoropolymer process aid for sites on the metal surface of the extruder die.

Others (U.S. Pat. Nos. 5,710,217 and 6,380,313 B1) have employed base-resistant fluoropolymers as process aids for use in melt processable polymers containing HALS. Base-resistant fluoropolymers contain no or a very low level of acidic hydrogen atoms. Examples of base-resistant fluoropolymers include, but are not limited to a) copolymers of tetrafluoroethylene and propylene and b) copolymers of tetrafluoroethylene, propylene and up to 10 weight percent of a copolymerized monomer that contains an acidic hydrogen atom such as vinylidene fluoride. However, base-resistant fluoropolymers generally do not function well as process aids for polyethylene, possibly because the lack of acidic hydrogen atoms decreases the tendency of the fluoropolymer to stick to the extruder die surface.

### SUMMARY OF THE INVENTION

It has been surprisingly discovered that fluoropolymers having relatively high levels of acidic hydrogen atoms (such as those on vinylidene fluoride) can be employed as process aids for non-fluorinated melt processable polymer compositions that contain HALS if polycaprolactone and a certain olefinic copolymer that is a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof are also present in the process aid composition.

Accordingly, one aspect of the present invention is an extrudable composition comprising:

A) a non-fluorinated melt processable polymer;

B) 10 to 2000 ppm, based on total weight of the extrudable composition, of a fluoropolymer process aid comprising i) a fluoropolymer comprising copolymerized units of a) at least 15 weight percent vinylidene fluoride and b) at least one other fluorine-containing copolymerizable monomer; ii) a polycaprolactone polymer; and iii) a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof; and

C) 500 to 10000 ppm, based on total weight of the extrudable composition, of a hindered amine light stabilizer.

Another aspect of the instant invention is a process for making a process aid composition comprising:

A) melt blending i) a fluoropolymer comprising copolymerized units of a) at least 15 weight percent vinylidene fluoride and b) at least one other fluorine-containing copolymerizable monomer with ii) a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof to form a mixture;

B) comminuting said mixture until a desired particle size is obtained; and

C) commingling said comminuted mixture with polycaprolactone polymer to form a process aid composition.

### DETAILED DESCRIPTION OF THE INVENTION

The present invention is directed to means for improving the extrusion processability of non-fluorinated melt processable polymer compositions that contain between 500 and 10,000 ppm of a hindered amine light stabilizer (HALS). The term “extrusion processability” as used herein refers to the conditioning time (i.e. the elapsed time between extruder start up when extruded articles exhibit a high degree of melt fracture and the time when an extrudate has a smooth surface, free of melt fracture). Obviously, in order to minimize waste and reduce costs, a very short conditioning time is desirable.

Examples of non-fluorinated melt processable polymers include, but are not limited to, thermoplastic hydrocarbon resins such as polyethylene, polypropylene and polystyrene. By the term “non-fluorinated” it is meant that the ratio of fluorine atoms to carbon atoms present in the polymer is less than 1:1, preferably 0:1. The non-fluorinated melt-processable polymers of this invention may be selected from a variety of polymer types. Such polymers include thermoplastic hydrocarbon polymers having melt indexes (measured according to ASTM D1238 at 190° C., using a 2160 g weight) of 5.0 g/10 minutes or less, preferably 2.0 g/10 minutes or less. The hydrocarbon polymers may be elastomeric copolymers of ethylene, propylene, and optionally a non-conjugated diene monomer, for example 1,4-hexadiene. In general, hydrocarbon polymers also include any thermoplastic hydrocarbon polymer obtained by the homopolymerization or copolymerization of a monoolefin of the formula CH₂═CHR, where R is H or an alkyl radical, usually of not more than eight carbon atoms. In particular, this invention is applicable to polyethylene, of both high density and low density, for example, polyethylenes having a density within the range 0.85 to 0.97 g/cm³; polypropylene; polybutene-1; poly(3-methylbutene); poly(methylpentene); and copolymers of ethylene and alpha-olefins such as propylene, butene-1, hexene-1, octene-1, decene-1, and octadecene. Hydrocarbon polymers may also include vinyl aromatic polymers such as polystyrene. Because specific hydrocarbon polymers exhibit differing melt characteristics, the practice of this invention may have greater utility in some hydrocarbon polymers than in others. Thus, hydrocarbon polymers such as polypropylene and branched polyethylene that are not of high molecular weight (e.g. having a weight average molecular weight less than about 80,000) have favorable melt flow characteristics even at lower temperatures, so that surface roughness and other surface defects can be avoided by adjustment of extrusion conditions. These hydrocarbon polymers may only require the use of the fluorocarbon polymer extrusion aids and process of this invention under unusual and exacting extrusion conditions. However, other polymers such as high molecular weight, high density polyethylene, linear low density polyethylene copolymers, high molecular weight polypropylene, and propylene copolymers with other olefins, particularly those with narrow molecular weight distributions, do not permit this degree of freedom in variation of extrusion conditions. It is particularly with these resins that improvements in the surface quality of the extruded product are obtained with the compositions and process of this invention.

Fluoropolymers useful in the compositions of this invention contain at least 50 (preferably at least 55, most preferably at least 60) weight percent fluorine and include elastomeric fluoropolymers (i.e. fluoroelastomers or amorphous fluoropolymers) and thermoplastic fluoropolymers (i.e. semi-crystalline fluoropolymers). The fluoropolymers are comprised of copolymerized units of at least 15 (preferably at least 30, most preferably at least 50) weight percent vinylidene fluoride and at least one other fluorine-containing copolymerizable monomer. Percentages of copolymerized monomer units are based on the total weight of the fluoropolymer. Examples of suitable copolymerizable fluorine-containing monomers include, but are not limited to hexafluoropropylene, tetrafluoroethylene, chlorotrifluoroethylene, 2-hydro-pentafluoropropylene, 1-hydro-pentafluoropropylene and fluorovinyl ethers such as perfluoro(methyl vinyl ether). The fluoropolymers employed in this invention may also contain copolymerized units of hydrocarbon copolymerizable olefins such as ethylene or propylene. In some cases these copolymers may also include bromine-containing comonomers as taught in Apotheker and Krusic, U.S. Pat. No. 4,035,565, or terminal iodo-groups, as taught in U.S. Pat. No. 4,243,770. The latter patent also discloses the use of iodo group-containing fluoroolefin comonomers. Fluoroelastomers useful in this invention are fluoropolymers that are normally in the fluid state at room temperature and above, i.e. fluoropolymers which have T_{g} values below room temperature, and which exhibit little or no crystallinity at room temperature.

Specific examples of fluoropolymers that may be employed in the compositions of this invention include copolymers of i) vinylidene fluoride and hexafluoropropylene; ii) vinylidene fluoride, hexafluoropropylene and tetrafluoroethylene; iii) vinylidene fluoride, perfluoro(methyl vinyl ether) and tetrafluoroethylene; and iv) vinylidene fluoride, tetrafluoroethylene and propylene, wherein all of the copolymers contain at least 15 weight percent copolymerized units of vinylidene fluoride and at least 50 weight percent fluorine.

If a single fluoropolymer is employed in the compositions of this invention, the fluoropolymer must be substantially molten at the process temperature of the non-fluorinated host polymer. If a fluoropolymer blend is used, at least one of the blend components must meet this criterion. If the molten component of the process aid is a fluoroelastomer, the Mooney viscosity (measured per ASTM-D1646 at 121° C., large rotor, condition ML 1+10 minutes) should be 100 or less, preferably 20 to 80, most preferably 60 to 80. If the molten component of the process aid is semi-crystalline, the melt index (ASTM D-1238, 265° C., 5 kg weight) must be greater than 0.5 dg/min., preferably in the range 0.5 to 3 dg/min.

A preferred polycaprolactone polymer for use in the compositions of this invention is derived from the ring opening reaction of epsilon-caprolactone. A preferred initiator is 1,4-butanediol. Other suitable initiators include, but are not limited to ethylene glycol, diethylene glycol, neopentyl glycol, pentaerythritol, 1,6-hexanediol, and alcohols such as methanol or ethanol. Preferably the polycaprolactone has a number average molecular weight in the range 1000 to 32000, more preferably 2000 to 10000, and most preferably 2000 to 4000. Suitable polycaprolactone polymers are sold under the trade names TONE™, CAPA® and PLACCEL®.

Another ingredient of the compositions of the invention is a certain olefinic copolymer that is a copolymer of a C₂-C₄ alpha olefin with at least 1 (preferably at least 2, most preferably at least 4) weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof. Percentages are based on the total weight of the olefinic copolymer. Specific examples of such copolymers include, but are not limited to ethylene/acrylic acid copolymers and ethylene/methacrylic acid copolymers. When at least some, but not all, of the pendant carboxyl groups are in the form of metal salts (i.e. a “partial metal salt”), rather than acid groups, the copolymers are commonly referred to as ionomer resins. Ionomer resins are well known in the art, for example U.S. Pat. No. 3,264,272. Suitable metal ions that may be contained in the salts include lithium, sodium, potassium, magnesium, calcium, barium, lead, tin, zinc or aluminum.

Process aid compositions may be made by any mixing or blending technique commonly employed in the elastomer or plastic industry such as an extruder, Buss® kneader, Farrel Continuous Mixer®, Banbury® mixer and the like. However, it has been found that pre-blending the fluoropolymer with the olefinic copolymer results in a process aid composition that has a surprisingly superior ability to improve the extrusion processability of non-fluorinated melt processable polymers that contain HALS. Thus, a preferred process for manufacturing process aid compositions comprises:

A) melt blending i) a fluoropolymer (as defined above) with ii) a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof to form a mixture;

B) comminuting the mixture until a desired particle size is reached; and

C) commingling the comminuted mixture with polycaprolactone polymer to produce a free flowing process aid composition. The process aid composition may be in the form of pellets, granules or powder as long as it can be readily handled by conventional solids feeding equipment.

For ease of processing, fluoropolymer process aids are often in the form of a masterbatch, rather than neat, when they are added to the non-fluorinated melt processable polymer to form the composition which is to be extruded. A masterbatch is a dispersion (mixture) of process aid in a diluent polymer. The diluent polymer can be the same non-fluorinated melt-processable polymer that is to be extruded, or it can be a second non-fluorinated melt processable polymer that does not deleteriously affect the extrusion behavior of the first non-fluorinated melt processable polymer/process aid composition. Masterbatches typically contain 0.5 to 50 wt. % of the above-defined process aid composition dispersed in non-fluorinated melt processable polymer. Percentages are based on the total weight of the masterbatch.

Process aids and masterbatches have both a weight ratio of fluoropolymer to polycaprolactone polymer and a weight ratio of fluoropolymer to olefinic copolymer in the range of 95:5 to 5:95, preferably 80:20 to 20:80, most preferably 70:30 to 30:70.

Masterbatches can be made by mixing a process aid composition with a non-fluorinated melt processable polymer in a suitable mixer such as a Banbury® mixer, twin screw extruder, etc. Alternatively, masterbatches may be made by first precompounding the appropriate amount of fluoropolymer with olefinic copolymer at a temperature above the melting point of both components, and then mixing the precompound with polycaprolactone and diluent polymer in a mixer. Masterbatches made by a process wherein the fluoropolymer and olefinic copolymer are not precompounded prior to addition of diluent polymer do not function as well as process aids in the presence of HALS, i.e. do not reduce conditioning time to the same extent as do masterbatches made from a precompound of fluoropolymer and olefinic copolymer.

The rate at which a fluoropolymer process aid composition or masterbatch is fed to an extruder is controlled so that the resulting extrudable composition of the invention comprises non-fluorinated melt processable polymer containing 500 to 10000 ppm of a hindered amine light stabilizer, between 10 and 2000 ppm (preferably 25 to 1000 ppm) of fluoropolymer, 10 to 2000 ppm (preferably 25 to 1000 ppm) polycaprolactone and 10 to 2000 ppm (preferably 25 to 1000 ppm) olefinic copolymer. All part per million (ppm) are by weight and are based on the total weight of the extrudable composition. Both the weight ratio of fluoropolymer to polycaprolactone polymer and the weight ratio of fluoropolymer to olefinic copolymer may be in the range of 95:5 to 5:95, preferably 80:20 to 20:80, most preferably 70:30 to 30:70.

The compositions of the invention are particularly useful in extrusions of melt processable non-fluorinated polymer, especially LLDPE, compositions that contain a hindered amine light stabilizer. Such extrusion processes are commonly used in manufacture of blown films, cast films and wire and cable jacketing.

### EXAMPLES

The following examples illustrate the significant improvement in extrusion processability, as evidenced by lower conditioning times, when process aid compositions of the invention are used in linear low density polyethylene (LLDPE) that contain a hindered amine light stabilizer.

The materials used in these examples were as follows:

The non-fluorinated melt processable polymer was a high molecular weight linear low density polyethylene, LL1001.29, available from ExxonMobil Corp. (hereinafter referred to as “LLDPE-1”).

The fluoropolymer used was a fluoroelastomer that was a copolymer of vinylidene fluoride and hexafluoropropylene, in a 60/40 weight ratio having a Mooney viscosity of 75 (measured per ASTM D-1646, large rotor, condition ML 1+10 minutes, measured at 121° C.) (hereinafter referred to as “FE-1”).

The polycaprolactone (PCL-1) polymer employed was derived from the ring opening reaction of epsilon-caprolactone, initiated by 1,4-butanediol and had a number average molecular weight of 4000.

The olefinic copolymer employed was Suryln® 8920 thermoplastic resin, available from DuPont (hereinafter “Ionomer-1”).

### Example 1

Precompounds were made by compounding FE-1 and Ionomer-1 in various ratios. Precompound 1 (70 wt. % FE-1, 30 wt. % Ionomer-1) was made in a Brabender mixing bowl operating at 100° C., 50 revolutions per minute (rpm). Precompound 2 (50 wt. % FE-1, 50 wt. % Ionomer-1) and Precompound 3 (25 wt. % FE-1, 75 wt. % Ionomer-1) were made in a 28 mm twin screw extruder operating at 200° C., 150 rpm.

Masterbatches of the invention (coded MB-1, etc.) were produced from the compositions shown in Table I (values are weight percent), using a 28 mm co-rotating twin screw extruder operating at 150 revolutions per minute (rpm) and 200° C. to melt mix the ingredients. The extruded strands were cooled in a water bath and pelletized.

TABLE I

| | Ingredient, wt. % | | |
|---|---|---|---|
| | MB-1 | MB-2 | MB-3 |
| LLDPE-1 | 97 | 97 | 97 |
| Precomound-1 | 1 | 0 | 0 |
| Precompound-2 | 0 | 1 | 0 |
| Precompound-3 | 0 | 0 | 1 |
| PCL-1 | 2 | 2 | 2 |

Other masterbatch compositions of the invention (MB-4 to MB-6) having the same level of ingredients as MB-1 to MB-3, but wherein the fluoropolymer and ionomer were not precompounded, were also made in the 28 mm extruder at 200° C., 150 rpm. A control (MB-A) that contained no olefinic copolymer (ionomer resin) was made by the same procedure. Formulations are shown in Table II.

TABLE II

Ingredient, wt. %

| | MB-4 | MB-5 | MB-6 | MB-A |
|---|---|---|---|---|
| LLDPE-1 | 97 | 97 | 97 | 97 |
| FE-1 | 0.7 | 0.5 | 0.25 | 0.25 |
| Ionomer-1 | 0.3 | 0.5 | 0.75 | 0 |
| PCL-1 | 2 | 2 | 2 | 2 |

Extrusion processability evaluations were carried out on blown film produced by a 63.5 mm extruder and a 101.6 mm diameter die having a 0.762 mm gap. Operating parameters were controlled by eight independent heating zones, and a pressure transducer.

In operation, all four die temperature zones were set to 190° C., and the extruder barrel temperatures were set at 160° C. (feed zone), 180° C. (middle), 194° C. (middle) and 194° C. (exit). The extruder screw speed was held constant at 45 rpm. Experiments were carried out by establishing a baseline condition of 100% melt fracture on the blown film using solely LLDPE-1 feed to the extruder, and allowing the extruder output and die pressure to reach steady state. The feed was then switched to a dry blend of the LLDPE-1, 1500 ppm CHIMASSORB® 944 HALS (available from Ciba Specialty Chemicals, Inc.), 5000 ppm diatomaceous earth anti-block and 2 weight percent of the masterbatch under evaluation. A digital timer with a one second readout was started to measure the conditioning time.

Samples of extrudate were taken at intervals, and the percent of surface area of the film covered by melt fracture defects was evaluated by visual inspection. The tests were run for 60 minutes. Film samples were taken every 10 minutes and the time required to achieve 0% melt fracture (i.e. the conditioning time) was recorded if this state was achieved during the test.

Upon completion of each test, the feed was switched to an abrasive purge compound containing 30% diatomaceous earth in polyethylene (807193, Ampacet Inc.) to remove fluoropolymer process aid from the extruder and die. After a thorough purging (30 to 45 minutes), the LLDPE was re-introduced to establish that the baseline conditions of die pressure, output, and melt fracture had been recovered.

Results of the extrusion tests are shown in Table III.

TABLE III

| | | % Melt Fracture at |
|---|---|---|
| Masterbatch | Conditioning Time (min.) | Completion of Test |
| MB-1 | 34 | 0 |
| MB-2 | 38 | 0 |
| MB-3 | >60 | 4 |
| MB-4 | >60 | 18 |
| MB-5 | >60 | 22 |
| MB-6 | >60 | 22 |
| MB-A | >60 | 39 |

The results in Table III show that the extrudable compositions of the invention, made from masterbatches of the invention (MB-1 to MB-3), containing precompounded fluoropolymer and ionomer, plus polycaprolactone, worked best to decrease the time required to eliminate melt fracture defects on the blown film. However, masterbatches of the invention (MB4 to MB-6) also showed improved performance versus the control (MB-A) which did not contain olefinic copolymer (ionomer).

What is claimed is:

1. An extrudable composition comprising:
A) a non-fluorinated melt processable polymer;
B) 10 to 2000 ppm, based on total weight of the extrudable composition, of a fluoropolymer process aid comprising i) a fluoropolymer comprising copolymerized units of a) at least 15 weight percent vinylidene fluoride and b) at least one other fluorine-containing copolymerizable monomer; ii) a polycaprolactone polymer; and iii) a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof; and
C) 500 to 10000 ppm, based on total weight of the extrudable composition, of a hindered amine light stabilizer.

2. An extrudable composition of claim 1 wherein component B iii) is selected from the group consisting of ethylene/acrylic acid copolymers, ethylene/methacrylic acid copolymers, and at least partial metal salts thereof.

3. An extrudable composition of claim 1 having a weight ratio of fluoropolymer to polycaprolactone of 80:20 to 20:80 and a weight ratio of fluoropolymer to component B iii) of 80:20 to 20:80.

4. An extrudable composition of claim 1 wherein said fluoropolymer is a fluoroelastomer.

5. An extrudable composition of claim 4 wherein said fluoroelastomer is a copolymer comprising units of vinylidene fluoride and hexafluoropropylene.

6. An extrudable composition of claim 11 wherein said fluoropolymer is a semi-crystalline fluoropolymer.

7. A process for making a process aid composition comprising:
A) melt blending i) a fluoropolymer comprising copolymerized units of a) at least 15 weight percent vinylidene fluoride and b) at least one other fluorine-containing copolymerizable monomer with ii) a copolymer of a C₂-C₄ alpha olefin with at least 1 weight percent of an α,β-ethylinically unsaturated monomer selected from the group consisting of a carboxylic acid, a dicarboxylic acid, a metal salt of a carboxylic acid, a metal salt of a dicarboxylic acid and mixtures thereof to form a mixture;
B) comminuting said mixture until a desired particle size is obtained; and
C) commingling said comminuted mixture with polycaprolactone polymer to form a process aid composition.

8. A process of claim 7 wherein said C₂-C₄ alpha olefin copolymer is selected from the group consisting of ethylene/acrylic acid copolymers, ethylene/methacrylic acid copolymers, and at least partial metal salts thereof.

9. A process of claim 7 wherein said process aid composition has a weight ratio of fluoropolymer to polycaprolactone of 80:20 to 20:80 and a weight ratio of fluoropolymer to C₂-C₄ alpha olefin copolymer of 80:20 to 20:80.

10. A process of claim 7 wherein said fluoropolymer is a fluoroelastomer.

11. A process of claim 7 wherein said fluoroelastomer is a copolymer comprising units of vinylidene fluoride and hexafluoropropylene.

12. A process of claim 7 wherein said fluoropolymer is a semi-crystalline fluoropolymer.
